(19) United States
(12) Patent Application Publication
(10) Pub. No.: US 2003/0005210 A1
(43) Pub. Date: Jan. 2, 2003

(54) Intelligent CAM cell for CIDR processor

(76) Inventors: Damodar Reddy Thummalapally, Milpitas, CA (US); Mohit Sharma, Richmond Town (IN); Pamela Kumar, Bangalore (IN)

Correspondence Address: ATTNE: THELEN REID & PRIEST LLP, P.O. BOX 640640, SAN JOSE, CA, 95164-0640, US

(21) Appl. No.: 09/865,241

(22) Filed: May 24, 2001

(51) Int. Cl. G06F 12/00

(52) U.S. Cl. 711/1; 711/108

(57) ABSTRACT

An intelligent content addressable memory (CAM) cell for CIDR co-processors is disclosed. The CAM cell is operative to search and compare external data from an external search data key with stored data. The CAM cell comprises means for containing the stored data and means for enabling a mask prefix read path for a work matching the external search data key. Furthermore, the CAM cell includes means for merging a mask prefix pattern of all matching entries in order to generate a device longest prefix match. A comparison is made between the device longest prefix match and word mask prefix data in order to find the desired data.

### FIELD OF THE INVENTION

The present invention relates to intelligent content addressable memory (CAM) cells for use in co-processors using Classless Inter Domain Routing (CIDR) protocol which is a subset of the Internet Protocol (IP). More particularly, the present invention relates to intelligent CAM cells for use as building blocks for a database and which are capable of performing a hierarchical search in the database.

### DESCRIPTION OF THE RELATED ART

Content addressable memory cells are well known in the art and are used to compare a search word with a set of stored words. An indication of whether or not the search word matches the stored words is produced for each stored word. A distinguishing characteristic of a CAM is that each stored word is uniquely identified on the basis of the content of the word itself, rather than by its address within the memory array.

A CAM includes an array of memory cells arranged in a matrix of rows and columns. Each memory cell stores a single bit of digital information. The bits stored in a row of memory elements constitute a stored word. During a match operation, a search word of input data is applied to all the rows, and an indication is produced for each row as to whether or not the search word matches the word stored therein.

An important use for a CAM is to facilitate searches on conventional indexed random access memory (RAM). The CAM stores a series of “tags” which represent address locations in the RAM. Match operations are performed on the CAM in order to detect the locations of data stored in the RAM. When match data is presented to the CAM, the CAM responds with a “tag” representing the address location in RAM containing the desired data. This address location is then driven to the RAM's address lines in order to access the data.

A common problem which is encountered in such types of search operations is when there is a “multiple match” (i.e., more than one row of the CAM tries to indicate a match with the match data). If the CAM lines are connected directly to the RAM's address lines, then a multiple match will cause more than one RAM address line to be asserted simultaneously. In such a situation, not only will some RAMS be incapable of responding properly, but assertion of multiple address lines may even be destructive for some RAMs.

U.S. Pat. No. 5,454,094 entitled METHOD AND APPARATUS FOR DETECTING MULTIPLE MATCHES IN A CONTENT ADDRESSABLE MEMORY, issued on Sep. 26, 1995 (the disclosure of which is incorporated by reference herein), attempts to overcome this problem by ensuring that when a CAM is used with a conventional RAM that is not suited to receive multiple matches, the RAM never sees more than one asserted address line. It also tries to ensure that the system is alerted to the fact that a multiple match has occurred, so that appropriate action may be taken (such as treating the stored data as invalid, or rechecking the CAM contents).

Consequently, U.S. Pat. No. 5,454,094 provides a method and apparatus for detecting multiple matches in a CAM. The invention according the '094 patent attempts to protect the attached RAM by ensuring that only one address line of the RAM is asserted at a time. It also provides a signal to alert the system that a multiple match has occurred.

In brief, the invention covered by U.S. Patent '094 converts information from the CAM lines into a logarithm index. It then converts this logarithm index into a unary code in which only one digit is asserted, and sends the unary code to the address lines of the RAM. Because the unary code never has more than one asserted digit, the RAM is protected from any multiple matches generated by the CAM.

If the information on the CAM lines has only one asserted digit, then the unary code will be identical to the CAM output. If, however, the CAM has asserted more than one address line, then the unary code will differ from the CAM output and will be inaccurate. This situation is detected by producing an inverted unary code and ANDing each digit of the inverted unary code with the corresponding digit of the original CAM output. If the result contains any asserted digits, then there has been a multiple match. A signal is generated to inform the system of this condition so that the unary code sent to the RAM can be ignored.

U.S. Pat. No. 6,101,573 entitled BIT LINE AND/OR MATCH LINE PARTITIONED CONTENT ADDRESSABLE MEMORY, issued on Aug. 8, 2000 (the disclosure of which is incorporated by reference herein), describes a bit line and/or match line partitioned content addressable memory. In brief, the '573 patent discloses cache memory formed of a content addressable memory and a cache RAM. The content addressable memory is divided into two or more sections by an AND gate array that serves to selectively either block or unblock the bit lines that supply an input data word to the bit storage and comparison cells of the content addressable memory. The generation of match signals for each section is also selectively blocked by preventing the match signal discharge to ground. The match signals from a blocked section are not passed to the RAM. The AND gate array and match signal disable may be controlled by the least significant bit of the input data word, higher order bits of the input data word, or may be controlled by a bit selected by program control from among the bits of the input data word. When a portion of the bit lines are blocked by the AND gate array, then the capacitance of the bit lines to be driven is reduced and the number of match lines discharged is halved thereby reducing power consumption.

According to the '573 patent, the content addressable memory has: a plurality of rows of bit storage and comparison cells within an array of bit storage and comparison cells wherein each row stores a data word. The memory further has a plurality of bits lines running through said array between corresponding bit storage and comparison cells within adjacent rows for transmitting an input data word from a data word input at one point on said bit lines along said bit lines to each row coupled to said bit lines. The input data word being compared with a respective stored data word by each row detects a match that is indicated by a match signal upon a match line for that row. The array is divided into at least two sections by one or more sets of gating circuits that operate to perform one or more of a) selectively blocking said input data word being transmitted along said bit lines beyond said gating circuits and b) selectively blocking generation of said match signals for at least one section. The gating circuits being controlled to block or unblock in response to at least one bit of said input data word.

The prior art recognizes that significant power consumption advantages can be achieved by partitioning the content addressable memory using gating circuits disposed in the bit lines running through the content addressable memory and/or disabling generation of match signal for a section of the content addressable memory. The sections of the content addressable memory thus formed can share their supporting circuitry, e.g. input circuitry, and so the modification requires only a small increase in circuit area through the provision of the gating circuits and control, and yet is able to provide a significant decrease in power consumption. Dividing the bit lines into sections has the result that when a portion of the bit line is blocked off by the gating circuit, the capacitance of the bit line being driven is reduced. Reducing the capacitance decreases the amount of power consumed in changing the signal value on the bit line. Blocking generation of the match signals for a section also decreases power consumption as these are normally all precharged and then all that do not match are discharged. At the same time, the '573 patent acknowledges that partitioning the content addressable memory reduces the associativity which is certainly a disadvantage, albeit a small one.

According to U.S. Pat. No. 5,568,415, entitled CONTENT ADDRESSABLE MEMORY HAVING A PAIR OF MEMORY CELLS STORING DON'T CARE STATES FOR ADDRESS TRANSLATION, issued on Oct. 22, 1996 (the disclosure of which is incorporated by reference herein), the content addressable memory has a pair of single-bit memory cells storing together two bits of information representing either an invalid state, a logic zero state, a logic one state, or a don't care state. Each of the memory cells has a pair of transistors. One of the transistors connects a common node to a respective one of a pair of address lines, and another of the transistors connects the common node to a potential of a predefined logic level. Each of the transistors has a gate receiving a logic level of the bit of information stored in a respective memory cell so that one of the transistors is conductive in response to the logic level of the bit of the information when the other of the transistors is not conductive in response to the logic level of the bit of information. Each of the memory cells also includes a transistor connected to the match line and having a gate connected to the common node. The content addressable memory is especially adapted for use in a translation buffer providing variable page granularity. The don't care states permit multiple virtual page numbers to match a single entry storing information for multiple physical pages. The invalid state eliminates the need for a dedicated valid bit in each entry.

U.S. Pat. No. 5,890,201, entitled CONTENT ADDRESSABLE MEMORY HAVING MEMORY CELLS STORING DON'T CARE STATES FOR ADDRESS TRANSLATION, issued on Mar. 30, 1999 (the disclosure of which is incorporated by reference herein), discloses a method of accessing a content addressable memory storing two bits of information representing either an invalid state, a logic zero state, a logic one state, or a don't care state. The stored information is compared with a one bit signal. A match is indicated when the one bit signal represents a logic zero and the stored information represents the don't care state, or when the one bit signal represents a logic one and the stored information represents a don't care state. An absence of a match is indicated when the one bit signal represents a logic zero and the stored information represents an invalid state, or when the one bit signal represents a logic one and the stored information represents the invalid state. The content addressable memory is especially adapted for use in a translation buffer providing variable page granularity. The don't care state permits multiple virtual page numbers to match a single entry storing information for multiple physical pages. The invalid state eliminates the need for a dedicated valid bit in each entry.

U.S. Pat. No. 6,118,682, entitled METHOD AND APPARATUS FOR READING MULTIPLE MATCHED ADDRESSES, issued on Sep. 13, 2000, (the disclosure of which is incorporated by reference herein) is directed toward providing a content addressable memory which enables multiple matches to be simply and efficiently examined during a multiple match cycle, regardless of the size of the storage device. For example, where two matched entries in a content addressable memory correspond to a search address, exemplary embodiments reduce the task of examining the locations of these matches to processing only two matched addresses as opposed to having to match all entries of the content addressable memory. By providing efficient access to multiple matched entries of a memory, the multiple matches can actually be used in an ordered manner to access different branches of a secondary memory. The use of a relatively simple control scheme enables the control logic to be implemented on a single integrated circuit chip with the memory device itself (e.g., a content addressable memory). Moreover, in contrast to conventional content addressable memories, the invention of the '682 patent enables the user to reset an original multiple matched condition, thereby allowing the user to perform several examinations of the data/address. Thus, if an error occurs during processing of multiple matches, the user can easily restart the examination process.

All the above-mentioned prior art recognize that in the current highly advanced state of information technology, the ability to store, obtain, access, retrieve and transmit information in the least possible time is highly critical. However, none of the currently available technology support the fast pace of state of the art systems. For instance in a 32-bit database system, it could take as long as 31 clock cycles to search and retrieve the stored data.

As the use of the Internet for voice and data communication increases, the need for faster and accurate transfer and retrieval of data increases.

Typically, data or voice communication over the Internet is performed in accordance with a specific protocol. Each protocol specifies how the data is sent from the source point to the destination point.

As mentioned earlier, the IP protocol governs data and voice communication over the Internet. The CIDR protocol, which is a subset of the IP protocol, governs addressing over the Internet. Under the CIDR protocol, the correct destination address is the one that is associated with the longest prefix. Each Internet address in the CIDR protocol is associated with an IP address and a sub-net mask value. In each router, routing tables are constructed out of prefix information and are searched using the destination address to determine the exit port of the router. According to the CIDR protocol, a sub-net mask value could only include a series of consecutive “1s” followed by “0s”. “1” represents that the corresponding bit in the associated IP address is used to determine the final physical address of the destination.

A transfer of information between two points begins by the user sending a packet of information to the receiver. Depending upon the location of the receiver, the information may have to travel through several networks before it reaches the receiver. It therefore, becomes very important that the information travels accurately through the shortest possible route from the sender to the receiver. It becomes all the more difficult because different destinations may have portions of their address in common with each other.

As the number of networks and destinations which are interconnected increases by the day, it is highly important that routers in each network are able to route the information as fast as possible to the final destination. The current technology takes a long time to determine the correct address in a router to route the information. For example, a 32 bit address could require up to 31 clock cycles to be determined in the currently available technology. In networks incorporating a wider address such as 128 bits, it would take more time to accurately determine the address of the final destination.

Thus there is a need for search cell capable of searching a database in the shortest possible time without compromising on the accuracy of the results.

The applicants' own co-pending application No. ______ filed on ______ overcomes many of the problems associated with the prior art and discloses a novel search cell for use as a building block of a database and which is capable of performing hierarchical searches in the database as well as a method thereof. The novel search cell of the co-pending application includes a plurality of Logic Content Addressable Memory Cells (LCAMS) arranged in rows and columns. Each LCAM cell includes first and second memory cells, a first comparator coupled to the first and second memory cells for comparing the content of the first memory cell with one bit of test information. To search for a second data type entry, the search cell searches for the longest prefix entry belonging to the first data type by comparing test information with the entries stored in the first storage unit. Once the longest prefix entry is determined, a corresponding entry in the second storage unit is output as the output of the search cell. The contents of said U.S. Patent Application are deemed to have been incorporated herein by reference.

### OBJECTS AND SUMMARY OF THE INVENTION

It is therefore, an object of the present invention to provide intelligent content addressable memory (CAM) cells for use in co-processors using Classless Inter Domain Routing (CIDR) protocol which avoids the disadvantages of the prior art.

It is a further object of the present invention to provide intelligent CAM cells and a search method using them which avoids pre-sorting for routing table entries.

It is yet another object of the present invention to provide a method using intelligent content addressable memory cells which avoid duplicate entries in routing table entries.

It is yet another object of the present invention to provide a simple method for deleting a specific entry in routing tables and auto updating algorithms to avoid duplicate entries in the database.

It is yet a further object of the present invention to provide a Tag cell with a reset path to invalidate a specific entry matching external search data and mask prefix data.

It is yet a further object of the present invention to provide a Tag cell with an option to invalidate all entries matching external search key data or an entry matching external search key data and mask prefix data.

It is another object of the present invention to provide a novel CAM cell for reducing search operation latency for results.

The above and other objects of the present invention are achieved by the novel intelligent content addressable memory cells of the present invention which particularly avoid pre-sorting of the routing table entries and also prevent duplication of entries and employ a novel search algorithm for performing the search operations.

The intelligent content addressable memory cells of the present invention comprise logic CAM cells (LCAM cells) that consist of a ternary CAM cell, at least a pair of mask prefix read path transistors, and at least a pair of prefix comparison transistors. The prefix comparison is between a device longest prefix match (DLPM) and word mask prefix data.

The typical environment in which the present invention will be utilized has been described in the applicant's co-pending application referred to above. The environment is typically a network such as the Internet which would include sub-networks that are connected according to a specific connection topology. The different topologies for connecting the networks will be known to a person skilled in the art. The networks themselves could be connected to each other through different communication means such as telephone lines, ISDN lines, satellites, and other means.

Each local network in a network configuration includes a router for routing the received packet of information to different destinations. Each router includes several input and output ports, each having a specific address connecting to multiple end points and subscribers. A port of a router may even be connected to the input port of another network.

Each network also includes a router table. The router table in each network stores the information used in the operation of the network. The information could include the physical address of the input/output ports of the respective router or the prefix information associated with the address of routers accessible through input /output ports.

The novel Search Algorithm of the present invention essentially consists of the following steps:

1. Comparison of external search key data (C/NC) with all valid entries in the entire routing table.

2. Generation of “device longest prefix match” (DLPM).

3. Comparison of DLPM pattern with mask prefix pattern of all entries, which matched with the external search key in step 1.

4. Accessing associated data for the entry, which has “associated data word line” (ADWL) asserted in step-3.

5. Generation of “system longest prefix match” (SLPM) pattern.

6. Sampling of SLPM and comparison of DLPM pattern.

7. Outputting the associated data read in step 4.

Comparison of external search key data with valid entries in the entire routing table is conventional. In a preferred embodiment, the routing table entries may be distributed among multiple devices in a depth cascaded system.

As will be clear to a person skilled in the art, in each entry, only unmasked data bits participate in comparison. The masked data bits do not participate in comparison. For every unique mask prefix pattern, there can be a maximum of one entry matching external search key in the entire routing table. Similarly, for a word width of 32 bits, there can be a maximum of 32 entries matching external search key data in the entire routing table.

Once the comparison is effected, MATCH-1L signals are asserted for the entries matching external search key data.

The “device longest prefix match (DLPM)” is generated by reading mask prefix pattern for all entries matching external key data in step 1. The MATCH-1L signals are used to enable mask prefix pattern read. The mask prefix pattern is read for entries, which have the MATCH-1L signal asserted. In each device in a depth cascaded system, the mask prefix pattern of all matching entries are read and merged to generate the “device longest prefix match (DLPM)”.

Comparison of the DLPM pattern with mask prefix pattern of all entries which matched with external search key in step 1 is performed by comparing Word Array Longest Prefix Match (WALPM) with DLPM to identify the word array which has an entry with a mask pattern the same as DLPM. The DLPM is driven on NLP (invert of DLPM) lines into a word array which has an entry matching the external key data in step-1 and also having the mask pattern the same as the DLPM. This completely dispenses with the conventional requirement to drive the DLPM into all word arrays, thereby resulting in a saving of time, as well as power.

Only one entry in the device will have a mask prefix pattern matching with the DLPM pattern. Each entry has an ADWL signal and will be asserted for the entry which:

a) has MATCH-1L asserted in step 1. (i.e. matched external search key data in step 1); and

b) has a mask prefix pattern which matches the DLPM.

Thereafter, associated data for the entry, which has ADWL asserted in step-3, is accessed. The ADWL signal is used to access the associated data memory cells.

Once the associated data is accessed, the “system longest prefix match” (SLPM) pattern is generated by merging the DLPM pattern from all devices on depth expansion (DBX) pins. The depth expansion pins, are common for all devices.

All devices need to sample DBX pins for SLPM and compare with their respective DLPM pattern. Only one device will have a DLPM matching SLPM. The device matching SLPM will output associated data read in step 4 on search results bus pins. The search results bus pins are common for all devices in a depth cascaded system. Only one device can drive the search results pins at a time.

The algorithm of the present invention is extremely suitable for pipeline architecture. In pipeline mode, the search results will be output every cycle.

The present invention also provides a novel method for matching by the following Matching Entry Algorithm:

1. Comparison of external search key data (L/NC) with all valid entries in the entire routing table. The routing table entries may be distributed among multiple devices in the depth cascaded system. As in the search operation, in each entry, only unmasked data bits participate in comparison. The masked data bits do not participate in the comparison. Again as in the search algorithm, for every unique mask prefix pattern, there can be a maximum of one entry matching external search key in the entire routing table. Likewise, for a word width of 32 bits, there can be a maximum of 32 entries matching external search key data in the entire routing table. After the comparison, MATCH-1L signals are asserted for the entries matching external search key data in a manner identical to step 1 of the search algorithm.

2. Driving the external mask prefix pattern on LP/NLP lines into word arrays which have matched in step 1. However, unlike the DLPM in the case of the Search operation, the external mask prefix pattern is driven onto LP/NLP lines. Thereafter, the external mask prefix pattern is compared with the mask prefix pattern of all entries that matched with the external search key in step 1. As can be appreciated, there can be a maximum of one entry in the routing table with the mask prefix pattern matching with the external mask prefix pattern.

Again, as in search algorithm, each entry has an ADWL signal. The ADWL will be asserted for the entry which:

a) has MATCH-1 L asserted in step 1. (i.e. matched external search key data in step 1); and

b) has a prefix pattern which matches the external mask prefix pattern.

3. Using the ADWL signal to access the tag cell and also the associated data cells.

For a delete matching entry command, logic ‘1’ will be written into the tag cell of the entry which has the ADWL asserted.

For write associated data of a matching entry command, the associated data is modified for the entry which has the ADWL asserted.

For read associated data of a matching entry command, the associated data is read for the entry which has the ADWL asserted.

4. Forcing all devices to output a “device match flag” information on an open drain output pin. If the external search key matches both the data and mask prefix patterns in the routing table, the NSMF pin will be asserted logic “0”. The device match flag is based on the ADWL signal.

5. Sampling of NSMF pin to find whether the entry exists in the routing table. This information can be used for various purposes.

6. Autoupdating of algorithm as follows:

(a) Issuing “read NLP of a matching entry”. The NSMF pin gets asserted (logic “0”) if an entry matching both data and mask prefix pattern exists in the database.

(b) Sampling NSMF pin.

If NSMF=‘1’ then issue “write entry to the database at a free location” command. The entry is added in the device which holds system free addresses. The existence of the free location indicates that the device is not full.

In a preferred embodiment, both steps (a) and (b) can be integrated into one command called Autoupdate. This command can be used to avoid duplicate entries in the routing table.

### BRIEF DESCRIPTION OF THE DRAWINGS

The present invention will now be described in greater detail with reference to the accompanying drawings wherein:

FIG. 1(a) is a block diagram of a first embodiment of the intelligent CAM of the present invention, which can be used to store routing tables using CIDR protocol and also avoid pre-sorting of the routing table entries.

FIG. 1(b) is a modified version of first embodiment of the intelligent cam shown in FIG. 1(a).

FIG. 2(a) is a block diagram of a second embodiment of the intelligent CAM of the present invention which can be used to store routing tables using the CIDR protocol and to avoid pre-sorting of the routing table entries as well as prevent duplication of entries.

FIG. 2(b) is a modified version of first embodiment shown in FIG. 2(a).

FIG. 3 is a block diagram of a typical word structure used in the intelligent CAM of the present invention.

FIG. 4 is block diagram of a typical sample array architecture of the present invention.

FIG. 5 is a schematic diagram for a word array prefix buffer/latch.

FIG. 6 is a schematic diagram for a MATCH-1 buffer/latch circuit.

FIG. 7 is a schematic diagram for a MATCH-2 buffer/latch circuit.

FIG. 8 is a schematic diagram of a prior art storage cell.

FIG. 9 is a schematic diagram of a prior art compare/XOR circuit

FIG. 10(a) is a schematic diagram of a prior art ternary CAM cell.

FIG. 10(b) is a schematic diagram for a variation of a prior art ternary CAM cell.

FIG. 11(a) is schematic diagram of a typical tag cell of the present invention.

FIG. 11(b) is a schematic diagram for second type of tag cell having the option for deletion of all entries matching the external search key.

### DETAILED DESCRIPTION OF PREFERRED EMBODIMENTS

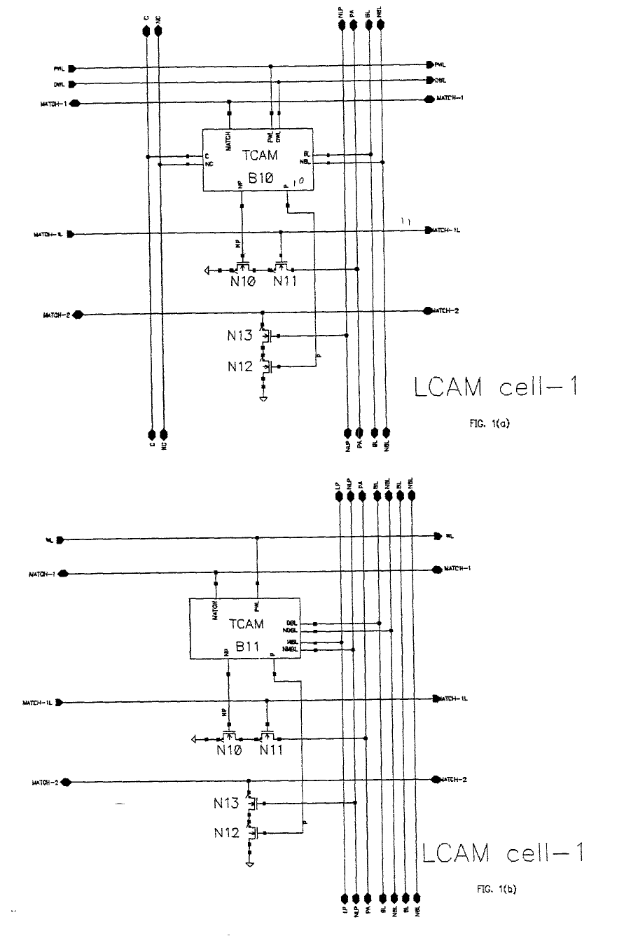

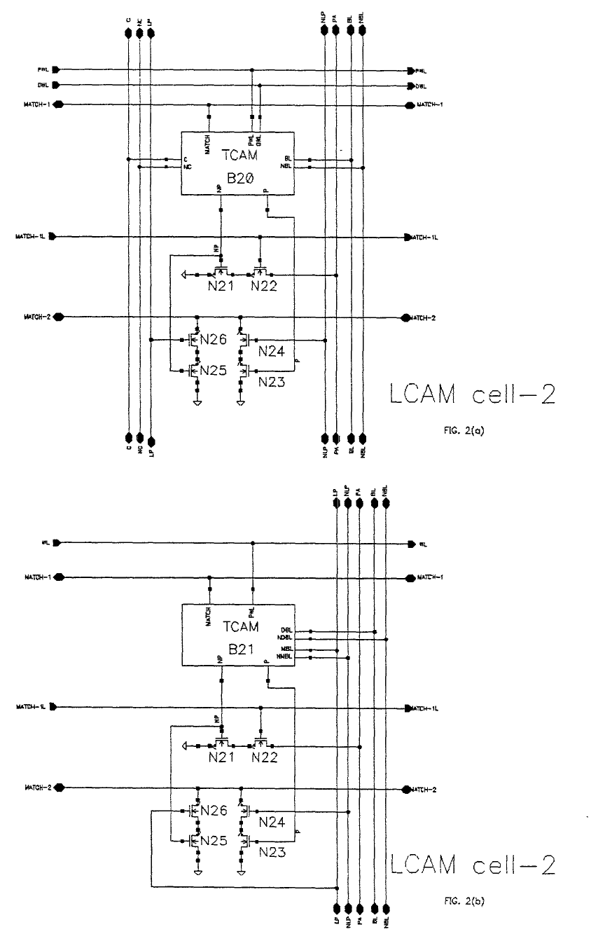

Referring to the drawings, FIG. 1(a) shows a schematic for a first embodiment of the novel logic CAM(LCAM) cell of the present invention. The LCAM cell consists of Ternary CAM cell B10, mask prefix read path transistors N10 and N11, and prefix comparison transistors N12 and N13. The prefix comparison is between device longest prefix match (DLPM) and word mask prefix data.

The chip may be divided into four quadrants. Each quadrant may be divided further into multiple arrays. Each array may be further divided into multiple word arrays. Each word array stores multiple words.

For a chip with four quadrants, 8 arrays per quadrant, 4 word arrays per array, and 32 words per word array, the total number of words (entries) in the device is equal to 4096 (=4*8*4*32).

In an array the words will be stacked in rows and columns. The words placed in a column is referred to as a word array. In the above example, each word array has 32 words.

The external search key data is driven onto C/NC lines. The stored data in the ternary CAM cells is compared with external search key data. As mentioned above, only unmasked bits in the word are compared against respective compare data lines C/NC.

The NMOS transistors N10 and N11 enable mask prefix P/NP read path for a word matching external search key data.

When mask prefix P=1 (NP=0), the data bit is referred as masked and doesn't participate in comparison with the respective external search key data bit.

The PA signals are precharged to logic ‘1’ level in the word array prefix latches prior to reading of the mask prefix.

MATCH-1L remains at low (logic ‘0’) for all words which do not match with external search key data.

When MATCH-1L is low, NMOS transistor N11 is OFF. For a matched entry, MATCH-L is asserted logic ‘1’ and NMOS transistor N11 is ON.

If MATCH-1L=1 and P=1, then N11 is ON and N10 is OFF. The PA signal is not affected with reading of this mask prefix bit.

If MATCH-1L=1 and P=0, then both N11 and N10 are ON. This results in discharge of PA to logic ‘0’ level (GND).

The device longest prefix match (DLPM) comparison logic consists of NMOS transistors N12 and N13. The MATCH-2 signal is precharged to logic ‘1’ level for entries matching external search key data prior to driving DLPM on NLP for comparison. If there is a mismatch between word mask prefix P and DLPM, the MATCH-2 is discharged to logic level ‘0’ (GND).

Only the following three valid combinations for P and DLPM are possible: 11, 10, 00. The signal NLP is an invert of DLPM. The MATCH-2 gets discharged to logic level ‘0’ (GND) if both transistors N12 and N13 are ON.

TABLE 1

| P | DLPM/NLP | MATCH2 Discharge Path |
|---|---|---|
| 1 | 1/0 | OFF as N13 is OFF |
| 1 | 0/1 | ON as both N12 and N13 are ON |
| 0 | 0/1 | OFF as N12 is OFF |

DWL is asserted to access (write/read) data storage cells. PWL is asserted to access (write/read) mask prefix storage cells. The BL/NBL are shared between data and mask cells for read/write path.

FIG. 1(b) depicts a variation of the embodiment shown in FIG. 1(a) wherein the data and mask prefix cells are accessed with the same wordline but use separate data paths (BL/NBL) for data cell, and LP/NLP for mask cell. The mask cell read/write data path and DLPM comparison write path share same data line NLP.

In FIGS. 2(a) and (b), a second embodiment of the logic CAM(LCAM) cell of the present invention is shown. This cell is similar to FIG. 1(a) but for two extra NMOS transistors N25 and N26. The NMOS transistors N23, N24, N25, and N26 form a regular COMPARE/XOR circuit as is well known in the art. The addition of the N25 and N26 transistors enables the device to support an additional feature of searching for an entry matching both data and mask prefix patterns.

To delete a specific entry in the routing table, entry data and mask patterns are checked. To match the specific mask pattern, a conventional comparator will be required.

The second pull down path N25-N26 covers four combinations of P=0 and LP=1.

TABLE 2

| P | LP/NLP | MATCH-2 Discharge Path |
|---|---|---|
| 1 | 1/0 | OFF as N13 is OFF |
| 1 | 0/1 | ON as both N12 and N13 are ON |
| 0 | 0/1 | OFF as N12 is OFF |
| 0 | 1/0 | ON as both N25 and N26 are ON |

With this LCAM cell, all matching entry commands can be implemented. The matching entry commands include:

Write Associated Data for matching entry,

Read Associated data of a matching entry,

Autoupdate, Delete Matching entry.

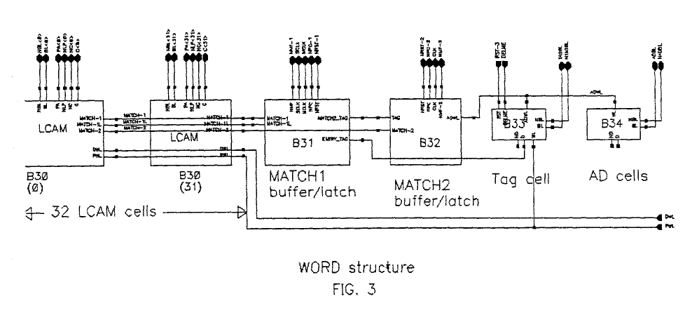

FIG. 3 illustrates a typical word structure for the disclosed invention. Each word consists of LCAM (logic CAM) cells, MATCH-1 buffer/latch, MATCH-2 buffer/latch, word tag cell, and Associated Data (AD) cells. The LCAM cells store word data and respective prefix pattern. Each word has a tag cell to store information to indicate whether it is a valid entry or not. When the device is reset, all words (entries) become invalid.

For each word, there are associated data cells. The associated data cells are used to store the position of the word or the next hop port id or parameters. The device outputs associated data on results bus pins if a match is found for external search key data.

All LCAM cells in a word share MATCH-1, MATCH-1L, and MATCH-2 signals. These signals run parallel to the wordline. Each word has a dedicated set of match signals MATCH-1, MATCH-1 L, and MATCH-2.

The bitlines BL/NBL, compare lines C/NC, prefix line P, and longest prefix line NLP run vertical and are shared among all words in a word array. Each bit in LCAM word array, there is a pair of BL/NBL signals, a pair of C/NC signals, prefix line P, and longest prefix line NLP. For 32-bit LCAM word, there will be 32 pairs of BL/NBL signals, 32 pairs of C/NC signals, 32 P signals, and 32 NLP signals.

The BL/NBL signals are used for word read and write operations. The C/NC signals carry external search key data for the MATCH-1 comparison.

The P signals are used for prefix reading in the word array for entries matching external search key. For entry(word) matching the external search key data, MATCH-1L is asserted. The prefix is read from entries which have MATCH-1L asserted. If multiple words match external search key, the merging of the prefix happens on the P lines during the prefix read.

The NLP signals carry inverted device longest prefix pattern for comparison with mask pattern of entries matching the external search key. The MATCH-2 buffer/latch output is used to access the word's associated data. This enables reading of associated data of an entry(word) matching the external search key and which also has longest prefix pattern.

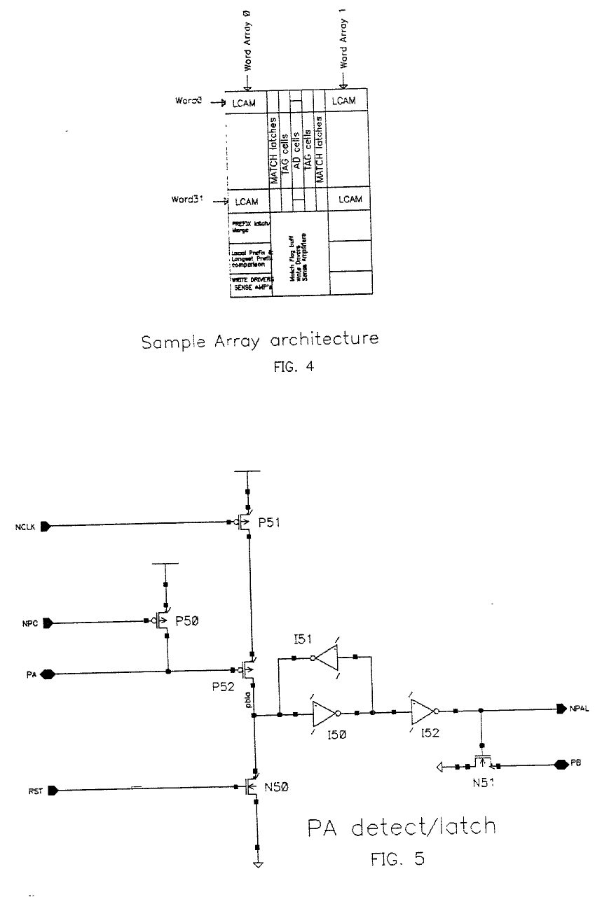

FIG. 4 shows sample array architecture of the present invention. There are two word arrays in the array. Each word array has 32 words. Each word array has dedicated prefix latches, comparator for word array longest prefix match(WALPM) and device LPM, write drivers for compare signals (C/NC), write path for NLP signals, sense amplifiers for LCAM cells read, and match flag latch. The associated data has dedicated write drivers for writing and sense amplifiers for reading.

The comparison between WALPM and DLPM is enabled by the respective word array MF signal. If MF=0, the mismatch between WALPM and DLPM is forced.

FIG. 5 proposes a typical circuit for a word array prefix buffer/latch in accordance with the present invention. The inverters 150 and 151 form a latch. The PMOS device P50 is used to precharge word array prefix signal PA.

The latch (150 and 151) can be reset through NMOS transistor N50.

The PMOS transistors P51 and P52 are used to sample the PA signal level into word array prefix latch (150 and 151). The PA signal sampling is done after the mask prefix for matched entries is read/merged.

The NMOS transistor N51 is used to merge word array prefixes to generate the device longest prefix match.

The PB signal is shared among all word arrays in one or multiple word arrays. The PB signal is precharged to logic ‘1’ level after the latch (150 and 151) is reset and before NCLK is asserted.

The word array prefix latch is reset prior to asserting the NCLK signal to sample the PA state.

The signals NPC and NCLK are active low signals, and is an active high signal. All signals NPC, NCLK and RST are timed signals.

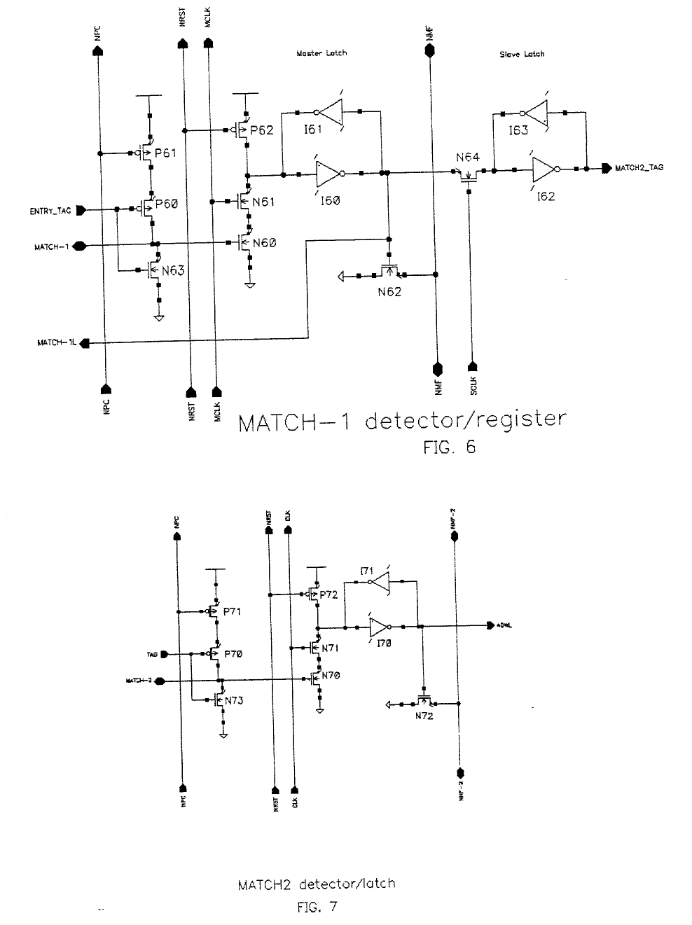

FIG. 6 shows the proposed circuit for MATCH-1 buffer/latch function in accordance with the invention. The inverters I60 and I61 form a master latch, and I62 and I63 form a slave latch. The PMOS devices P60 and P61 form a precharge path to logic level ‘1’ for MATCH-1 signal. The signal ENTRY_TAG will be ‘0’ for a valid entry and is equal to logic ‘1’ for invalid entry.

For an invalid entry (ENTRY_TAG=1), the MATCH-1 signal remains at logic ‘0’ as NMOS transistor N63 is ON and PMOS transistor P60 is OFF.

The master latch (I60 and I61) can be reset through PMOS transistor P62.

The transistor N64 is used to transfer master latch (I60 and I61)data to slave latch (I62 and I63).

The NMOS transistors N60 and N61 are used to sample the MATCH-1 signal level into the master latch (I60 and I61).

The NMOS transistor N62 is used to read match information for the word array. The NMF signal is common to all words in a word array. The NMF signal is precharged to logic ‘1’ level after the master latch (I60 and I61) is reset and before MCLK is asserted.

The MATCH-1 master latch is reset prior to asserting MCLK signal to sample MATCH-1 status into the master latch. The MATCH-1 slave latch clock SCLK is asserted to transfer the master latch data (I60 and I61) into the slave latch (I62 and I63). The output of the slave latch MATCH-2 i.e. MATCH-2_TAG is used to control MATCH-2 precharge path.

The MATCH-1L signal is the MATCH-1 master latch output. This is routed to all LCAM bits in the word to enable the prefix (mask bits) read path for the word.

The signals NPC and NRST are active low, and MCLK and SCLK are active high signals. All the signals NPC, NRST, MCLK and SCLK are timed signals.

FIG. 7 shows the inventive MATCH-2 buffer/latch function. The inverters I70 and I71 form a latch. The PMOS devices P70 and P71 form precharge path to logic level ‘1’ for the MATCH-2 signal. The signal MATCH-2 TAG goes to logic ‘1’ for an entry matching the external search key.

For mismatched entries (MATCH-2 TAG=O), the MATCH-2 signal remains at logic ‘0’ as NMOS transistor N73 is ON and PMOS transistor P80 is OFF.

The latch (I70 and I71) can be reset through PMOS transistor P72.

The NMOS transistors N70 and N71 are used to sample the MATCH-2 signal level into latch (I70 and I71). The MATCH-2 sampling is done after comparison between DLPM (device longest prefix match) and the prefix of entries with MATCH-1L asserted is over.

The NMOS transistor N72 is used to read match information for the word array. The NMF signal is common to all words in a word array.

The NMF signal is precharged to a logic ‘1’ level after the latch (I70 and I71) is reset and before CLK is asserted.

The MATCH-2 latch is reset prior to asserting the CLK signal to sample MATCH-2 status. ADWL signal is the latch output. The ADWL is used as a wordline for associated data cells.

The signals NPC and NRST are active low signals, and CLK is active high signal. All the signals NPC, NRST and CLK are timed signals.

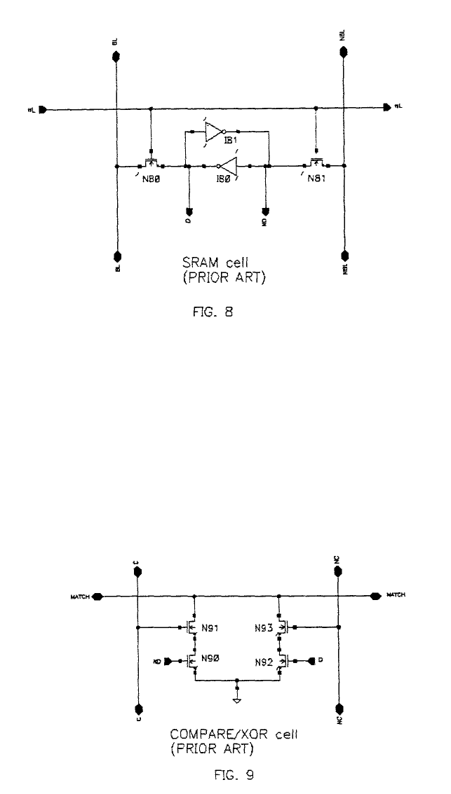

FIG. 8 discloses a typical prior art storage cell. The inverters I80 and I81 form a latch. The NMOS transistors N80 and N81 are access transistors. To access the bit for cell read/write, the wordline WL has to be asserted (logic ‘1’). The BL/NBL are precharged prior to WL assertion. To write into cell, data is put on BL and inverted data is put on NBL by write drivers, and the wordline is asserted. To read stored data in the cell, precharge the BL and NBL to logic ‘1’ followed by an assertion of wordline. The storage cell drives BL and NBL after WL is asserted. If storage cell has D=0 and ND=1, the BL is discharged towards GND level and NBL remains at precharged logic ‘1’ level. A sense amplifier is used to sense voltage difference between BL and NBL to determine storage cell data. The storage cell is used in ternray CAM cells, tag cells, and associated data cells.

FIG. 9 discloses a conventional comparison cell (XOR). There are two possible paths (N90-N91 and N92-N93) for discharging MATCH signal to GND.

The MATCH line is precharged to logic ‘1’ level prior to enabling comparison. If C=D=0 or C=D=1, there is no discharge path to GND.

If C/NC=0/1 and D/ND=1/0, N91 is OFF and N90 is OFF, N92 is ON and N93 is ON, the MATCH signal is discharged to GND (logic level ‘0’) through N92-N93 discharge path. This corresponds to a mismatch.

If C/NC=1/0 and D/ND=0/1, N91 is ON and N90 is ON, N92 is OFF and N93 is OFF, the MATCH signal is discharged to GND (logic level ‘0’) through N90-N91 discharge path. This corresponds to a mismatch.

If C/NC=0/1 and D/ND=0/1, N91 is OFF and N90 is ON, N92 is OFF and N93 is ON, the MATCH signal remains at logic level ‘1’ as both discharge paths N90-N91 and N92-N93 are off. This corresponds to a match.

If C/NC=1/0 and D/ND=1/0, N91 is ON and N90 is OFF, N92 is ON and N93 is OFF, the MATCH signal remains at logic level ‘1’ as both discharge paths N90-N91 and N92-N93 are off. This corresponds to a match.

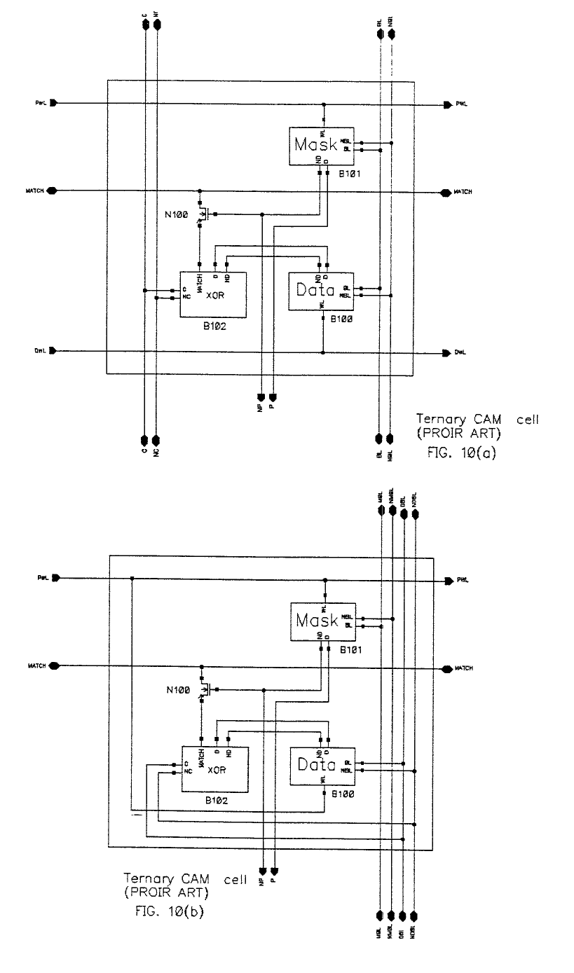

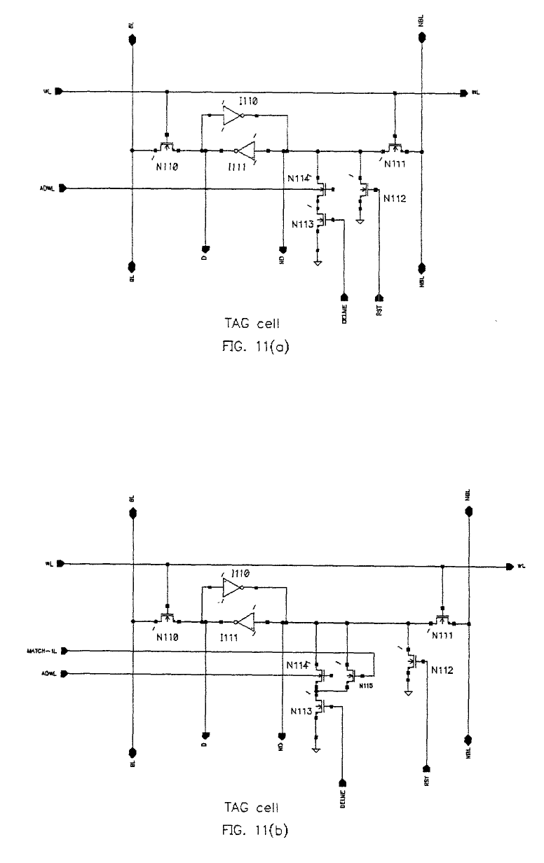

FIGS. 10(a) and (b) shows a conventional ternary CAM cell. It has two storage cells (i.e. FIG. 9) (B100 and B101) and one compare cell (B102). The B100 is used to store data and B111 to store a respective mask data. The NMOS transistor 100 is used to enable or disable comparison. The external search data C/NC is compared with stored data D/ND.

When mask data P/NP=1/0, N100 is OFF, the comparison is disabled for this bit. In other words, this TCAM data bit in the word doesn't participate in comparison.

When mask data P/NP=0/1, N100 is ON, the comparison is enabled for this bit. In other words, this TCAM data bit in the word participates in comparison.

The following non-limitative examples will illustrate how the LCAM's of the present invention works.

Database: Example

Assumptions:

LCAM word width of 8 bits.

AD word width of 4 bits.

four valid entries(words) in device0, word array0.

three valid entries(words) in device0, word array1.

No valid entries in other devices in modules.

| | | | |
|---|---|---|---|
| Entry | Data | Mask | AD |

Device 0: Word Array 0

| | | | |
|---|---|---|---|
| 1 | 0110 1000 | 0011 1111 | 1111 |
| 2 | 1110 1000 | 0011 1111 | 1110 |
| 3 | 0110 1000 | 0000 0011 | 0001 |
| 4 | 0111 1111 | 0001 1111 | 0011 |

Device 0: Word Array 1

| | | | |
|---|---|---|---|
| 5 | 1110 1000 | 0000 1111 | 0111 |
| 6 | 1111 1000 | 0111 1111 | 1011 |
| 7 | 0110 1000 | 0000 0111 | 1001 |

Search Algorithm: Example Illustration

===

External Search Key data:

0110 1001

Step 1:

Match-1 signals are precharged to logic ‘1’s level for all valid entries in the device. In the above example, seven entries are precharged to logic ‘1’ level in the device.

The external search key data 0110 1001 is driven on C<7:0> signals and inverted key data 1001 0110 is driven on NC<7:0> signals in all word arrays on the device.

The entries 1, 3, 4, and 7 match with external key data. The MATCH-1 signals for entries 1, 3, 4, and 7 remain in precharged logic level ‘1’ and MATCH-1 signals for mismatched entries discharge to logic level ‘0’ (GND).

The MATCH-1 latches are reset prior to sampling MATCH-1 level. The MATCH-1L signals for all entries on the device go to logic level ‘0’ with reset.

The MATCH-1 signal sampling is done by asserting the MCLK signal.

After MATCH-1 sampling, the MATCH-1L signals for entries 1, 3, 4, and 7 go to logic level ‘1’.

Step 2:

The word array prefix PA<7:0> are precharged to logic level ‘1’ in all word arrays prior to MATCH-1 signal sampling, i.e., prior to assertion of MCLK.

After the MATCH-1 signal sampling, the mask prefix read is enabled for entries 1, 3, 4, and 7.

For word array 0, the PA<7:0> becomes 0000 0011. This word array prefix corresponds to entry 3, which has longest prefix match among entries 1, 3, and 4.

For word array 1, the PA<7:0> becomes 0000 0111. This word array prefix corresponds to entry 7.

The word array prefix latches are reset prior to sampling of PA<7:0> in all word arrays.

The PA<7:0> signals in both arrays are sampled into respective word array prefix latches. After the word array prefix of both word arrays WALPM<7:0> becomes 0000 0011 (NPAL<7:0>=1111 1100) for word array 0, and WALPM<7:0> becomes 0000 0111 (NAPL<7:0>=1111 1000) for word array 1.

The word array prefixes from both word arrays are merged to generate the DLPM. The DLPM<7:0> becomes 0000 0011 which corresponds to the prefix of word array 0.

Step 3:

The DLPM<7:0> is compared with WALPM<7:0> of both word arrays. The WALPM<7:0> of word array 0 matches with DLPM<7:0>. That means the entry with device longest prefix match is present in word array 0.

The MATCH-2 signals are precharged to logic level ‘1’ for entries 1, 3, 4, and 7 prior to driving NDLPM<7:0> onto NLP<7:0>. The NLP<7:0>=0000 0000 during the MATCH-2 precharge. The MATCH-2 signals are at logic level ‘0’ for entries 2, 5, and 6.

The NDLPM<7:0> is driven onto NLP<7:0> in word array 0 for comparison with mask prefix pattern for entries 1, 3, and 4.

The MATCH-2 for entry 3 remains at precharged logic level ‘1’ as its mask prefix data 0000 0011 matches with the DLPM<7:0>.

The MATCH-2 signals for entries 1 and 4 go to logic level ‘0’ due to a mismatch of the mask prefix with DLPM<7:0>.

The MATCH-2 signal for entry 7 is discharged to logic level ‘0’ when SCLK is asserted in next cycle.

The ADWL is asserted for entry 3 when MATCH-2 is sampled.

Step 4: The AD (0001) of entry 3 is read and latched on the device.

Step 5:

The System LPM is precharged to logic level ‘1’.

The device 0 outputs DLPM<7:0> onto SLPM<7:0>.

Assumed no valid entries in other devices in module.

Step 6:

The SLPM<7:0> is sampled by all devices in the module and compared with respective DLPM<7:0>.

The device 0 generates WIN signal as its DLPM<7:0> matches with SLPM<7:0>.

Step 7:

The device 0 outputs latched AD data 0001 onto search results pins. Matching Entry Command: Read AD of a matching entry

The following non-limitative example will illustrate the Search Algorithm of the present invention.

===

External Search Key data : 0110 1001

External mask prefix data: 0001 1111

Step 1:

Match-1 signals are precharged to a logic ‘1’ level for all valid entries in the device. In the above example, seven entries are precharged to logic ‘1’ level in the device.

The external search key data 0110 1001 is driven on C<7:0> signals and inverted key data 1001 0110 is driven on NC<7:0> signals in all word arrays on the device.

The entries 1, 3, 4, and 7 match with external key data. The MATCH-1 signals for entries 1,3,4, and 7 remain in precharged logic level ‘1’ and NL-MACH-1 signals for mismatched entries discharge to logic level ‘0’ (GND).

The MATCH-1 latches are reset prior to sampling MATCH-1 level. The MATCH-1 L signals for all entries on the device go to logic level ‘0’ with reset. The MATCH-1 signal sampling is done by asserting MCLK signal.

After MATCH-1 sampling, the MATCH-1L signals for entries 1, 3, 4, and 7 go to logic level ‘1’.

Step 2:

The MATCH-2 signals are precharged to logic level ‘1’ for entries 1, 3, 4, and 7 prior to driving external mask prefix onto LP/NLP lines into word arrays where match(es) were found in step 1.

The external mask prefix 0001 1111 is driven on LP<7:0> signals and inverted prefix data 1110 0000 is driven onto NLP<7:0> into both word arrays.

The LP<7:0>=NLP<7:0>=0000 0000 during MATCH-2 precharge.

The MATCH-2 signals are at logic level ‘0’ for entries 2, 5, and 6.

The MATCH-2 for entry 4 remains at precharged logic level ‘1’ as its mask prefix data 0001 1111 matches with external prefix data 0001 1111.

The MATCH-2 signals for entries 1,3, and 7 go to logic level ‘0’ due to mismatch.

The ADWL is asserted for entry 4 when MATCH-2 is sampled.

Step 3:

The AD (0011) of entry is read and latched on the device.

Step 4:

The device 0 drives NSMF to logic level ‘0’ indicating the external search key exists in it.

Additional modifications and improvements of the present invention may also be apparent to those of ordinary skill in the art such as using different discrete devices. Thus, the particular combination of parts described and illustrated herein is intended to represent only certain embodiments of the present invention, and is not intended to serve as limitations of alternative devices within the spirit and scope of the invention.

1. An Intelligent content addressable memory (CAM) cell for CIDR co-processors for searching and comparing an external data from an external search data key with stored data, comprising:
a means containing stored data;
means for enabling a mask prefix P/NP read path for a word matching the external search data key;
means for merging a mask prefix pattern of all matching entries to generate a device longest prefix match (DLPM); and
means for effecting comparison between the device longest prefix match and a word mask prefix data.

2. The intelligent content addressable memory cell of claim 1 wherein said means containing stored data is a ternary CAM cell.

3. The intelligent content addressable memory cell of claim 1 wherein said means containing stored data is a logic content addressable memory cell.

4. The intelligent content addressable memory cell of claim 3 wherein said logic content addressable memory cell comprises first and second memory cells; and
a first comparator coupled to said first and second memory cells, said first comparator comparing a content of said first memory cell with one bit of external search key data, said first comparator being controlled by the content of said second memory cell.

5. The intelligent content addressable memory cell of claim 4 further including a second comparator coupled to said second memory cell and a local mask bus, said second comparator comparing the content of said second memory cell with one bit of information present on the local mask bus; and
a cell logic circuit coupled with said second memory cell and local mask bus, said cell logic circuit receiving a control signal for enabling said logic circuit.

6. The intelligent content addressable memory cell of claim 1 wherein said first comparator generates an output signal indicating an existence of a match if the content of the first memory cell matches said one bit from said external search data key.

7. The intelligent content addressable memory cell of claim 1 wherein said means for enabling the mask prefix P/NP read path for a word matching the external search data key comprises one or more mask prefix read path transistors.

8. The intelligent content addressable memory cell of claim 7 wherein said means for searching an entry matching both data and mask prefix pattern comprises a pair of NMOS transistors connected to said means containing stored data.

9. The intelligent content addressable memory cell of claim 1 wherein said means for effecting comparison between the device longest prefix match and the word mask prefix data comprises one or more prefix comparison transistors.

10. The intelligent content addressable memory cell of claim 1 further including means for searching an entry matching both data and mask prefix pattern.

11. In a data base including a plurality of intelligent content addressable memory cells used for searching operations in a CIDR protocol in a network environment having routers for routing received packets of information to different destinations and router tables storing information for use in said search operations, the stored information being in the form of a plurality of arrays having a plurality of word arrays, which in turn store a plurality of words, a method for searching an entry from a second data type corresponding to a longest entry from the first data type using an external search data key, the method comprising:
(1) comparing the external search key data (C/NC) with all valid entries in the entire routing table;
(2) generating a device longest prefix match (DLPM);
(3) comparing the DLPM pattern with a mask prefix pattern of all entries, which matched with external search key in step 1;
(4) accessing associated data for the entry which has an ADWL asserted in step-3;
(5) generating a system longest prefix match (SLPM) pattern;
(6) sampling the SLPM and comparing it with the DLPM pattern; and
(7) outputting the associated data read in step 4.

12. The method of claim 11 wherein subsequent to comparison in step (1), MATCH-1L signals are asserted for the entries matching external search key data.

13. The method of claim 11 wherein the device longest prefix data is generated by reading the match prefix pattern for all entries matching external key data in step (1), enabling a mask prefix pattern read from MATCH-1L signals for entries which have MATCH-1L signals asserted, generating a word array longest prefix match (WALPM) and merging the match prefix pattern for all entries to generate said device longest prefix data.

14. The method of claim 11 wherein the word array longest prefix match is compared with said device longest prefix match to identify the word array which has an entry with a mask pattern the same as said device longest prefix match, and said device longest prefix match is driven on NLP (invert of DLPM) lines into the word array which has an entry matching, the external search key data in step (1) and a mask pattern matching said device longest prefix match and asserting ADWL signal.

15. The method of claim 14 wherein said ADWL signal is asserted for the entry which has (a) MATCH-1L asserted in step (1) and (b) has a mask prefix pattern matching with said device longest prefix match.

16. The method of claim 11 wherein said system longest prefix match pattern is generated by merging said DLPM patterns from all devices on depth expansion pins.

17. In a data base including a plurality of intelligent content addressable memory cells used for searching operations in a CIDR protocol in a network environment having routers for routing received packets of information to different destinations and router tables storing information for use in said search operations, the stored information being in the form of a plurality of arrays having a plurality of word arrays, which in turn store a plurality of words, a method for matching which comprises:
(1) comparing the external search key data (C/NC) with all valid entries in the entire routing table;
(2) driving an external mask prefix pattern on LP/NLP lines into word arrays which have matched in step (1);
(3) comparing the external mask prefix pattern of all entries which matched with the external search key in step (1);
(4) asserting an ADWL signal for each entry which has (a) MATCH-1L asserted in step (1) and (b) has mask prefix pattern matching with said device longest prefix match;
(5) accessing a tag cell and associated data cells with said ADWL signal for deleting the matching entry, writing associated data of the matching entry or for reading associated data of the matching entry;
(6) outputting device match flag information from all devices on an open drain output pin;
(7) subjecting all devices to sample a NSMF pin to ascertain whether the entry exists in the routing table; and
(8) autoupdating to avoid duplicate entries in the routing table.

18. The method of claim 17 wherein after the comparison in step (1) MATCH-1L signals are asserted for the entries matching said external search key data.

19. The method of claim 17 wherein in step (4) if the external search data key matching both data and match prefix pattern exists in the routing table the NSMF pin is asserted logic ‘0’.

20. The method as claimed in claim 17 wherein said step of autoupdating includes:
(a) issuing a read NHP of a matching entry to assert that said NSMF pin gets asserted logic ‘0’ if the entry matching both data and mask prefix patterns exists in the database, and (b) sampling the NSMF pin and if NSMF=‘1’ then issuing a write entry to the database at a free location command.

21. The method of claim 20 wherein said steps (a) and (b) are integrated into a single autoupdate command to avoid duplicate entries in the routing table.

22. A word structure for CIDR co-processors for use in searching operations and comparing an external data from an external search data key with a stored data comprising:
one or more logic CAM (LCAM) cells;
at least a MATCH-1 buffer/latch connected to said one or more Logic CAM cells;
at least a MATCH-2 buffer/latch;
a word tag cell for each word; and
one or more associated data cells.

23. The word structure of claim 22 wherein each said LCAM comprises a plurality of arrays, said plurality of arrays being divided into a plurality of word arrays, each of said plurality of word arrays storing a plurality of words, said words being stored in the form of plurality of wordlines and each of said wordlines comprising of a plurality of bitlines.

24. The word structure of claim 22 wherein said one or more Logic CAM cells, said at least a MATCH-1 buffer/latch, said at least a MATCH-2 buffer/latch, said word tag cell and said one or more associated data cells are connected in series.

25. The word structure of claim 22 wherein said LCAM cells store word data and respective prefix patterns.

26. The word structure of claim 22 wherein each word tag cell stores information to indicate the presence or absence of valid entries.

27. The word structure of claim 22 wherein when the device is reset, all the entries become invalid.

28. The word structure of claim 22 wherein said associated data cells store a position of the word.

29. The word structure of claim 22 wherein all LCAM cells in a word share MATCH-1, MATCH-1L, and MATCH-2 signals.

30. The word structure of claim 29 wherein said MATCH-1, MATCH-1L, and MATCH-2 signals run parallel to a wordline.

31. The word structure of claim 30 wherein each word has a dedicated set of match signals: MATCH-1, MATCH-1L, and MATCH-2.

32. The word structure of claim 30 wherein each wordline comprises a plurality of bit lines.

33. The word structure of claim 23 wherein for each bit in a LCAM word array, there is a pair of BL/NBL signals, a pair of C/NC signals, a prefix line P, and a longest prefix line NLP.

34. The word structure of claim 33 wherein said bitlines compare external search key data lines and the prefix line to generate a longest prefix line NLP which runs vertical to and is shared among all words in said word array.

35. The word structure of claim 34 wherein said BL/NBL signals are used for word read and write operations and said C/NC signals carry external search key data for MATCH-1 comparison.

36. The word structure of claim 33 wherein the P signals are used for prefix reading in the word array for entries matching external search key.

37. The word structure of claim 33 wherein the prefix is read from entries which have MATCH-1L asserted.

38. The word structure of claim 33 wherein if multiple words match the external search key, the merging of the prefix happens on P lines during a prefix read.

39. The word structure of claim 33 wherein the NLP signals carry an inverted device longest prefix pattern for comparison with a mask pattern of entries matching the external search key and the MATCH-2 buffer/latch output is used to access the word's associated data for enabling reading of associated data of an entry(word) matching the external search key and which also has longest prefix pattern.

40. A word array prefix buffer/latch circuit for use with intelligent CAM cells in a CIDR coprocessor, comprising:
a first inverter means;
a second inverter means connected in parallel to said first inverter means to form a latch means;
a PMOS device connected to said latch means for precharging said word array prefix circuit; and
an NMOS transistor connected to said latch means for resetting said latch means.

41. The word array prefix buffer/latch circuit of claim 41 further including a pair of PMOS transistors connected between said PMOS device and said latch means to sample a PA signal level into said latch means.

42. The word array prefix buffer/latch circuit of claim 40 wherein said NMOS transistor merges word array prefixes to generate a device longest prefix match.

43. A MATCH-1 buffer/latch circuit for use with intelligent CAM cells in a CIDR coprocessor, comprising:
a first and second invertor connected in parallel to form a master latch;
a third and fourth invertor connected in parallel to each other to form a slave latch; and
a pair of PMOS devices connected to said master latch to form a precharge path to logic level ‘1’ for MATCH-1 signal.

44. The MATCH-1 buffer/latch circuit of claim 43 further including a PMOS transistor connected to said master latch for resetting said master latch.

45. The MATCH-1 buffer/latch circuit of claim 43 further including means connected between said master latch and said slave latch for transferring data from said master latch to said slave latch.

46. The MATCH-1 buffer/latch circuit of claim 45 wherein said means for transferring data comprises a further transistor.

47. The MATCH-1 buffer/latch circuit of claim 43 further including a pair of transistors connected to said master latch for sampling a MATCH-1 signal level into said master latch.

48. A MATCH-2 buffer/latch circuit for use with intelligent CAM cells in a CIDR coprocessor, comprising:
a first and second invertor connected in parallel to form a latch; and
a pair of PMOS devices connected to said latch and forming a precharge path to logic level ‘1’ for a MATCH-2 signal.

49. The MATCH-2 buffer/latch circuit of claim 48 further including means for resetting said latch.

50. The MATCH-2 buffer/latch circuit of claim 49 wherein said means for resetting comprises a further PMOS transistor connected to said latch.

51. The MATCH-2 buffer/latch circuit of claim 49 further including a first and second NMOS transistors connected to said latch for sampling the MATCH-2 signal level into said latch.

52. The MATCH-2 buffer/latch circuit of claim 51 wherein said sampling is carried out after comparison between a device longest prefix match and a prefix of entries with MATCH-1L.

53. The MATCH-2 buffer/latch circuit of claim 51 wherein a third NMOS transistor is connected to said latch for for reading match information for the word array.

54. The MATCH-2 buffer/latch circuit of claim 52 wherein MATCH-1 latch is preset prior to asserting a CLK signal to sample the MATCH-2 status.

55. The MATCH-2 buffer/latch circuit of claim 48 wherein the latch output comprises an ADWL signal which is used as a wordline for associated data cells.
